(19) United States
(12) Patent Application Publication
(10) Pub. No.: US 2025/0005970 A1
(43) Pub. Date: Jan. 2, 2025

(54) DEPLOYING MACHINE LEARNING MODELS FOR CONDITION-BASED AIRCRAFT MAINTENANCE

(71) Applicant: THE BOEING COMPANY, Arlington, VA (US)

(72) Inventors: Christie L. GAN, Seattle, WA (US); Jun YUAN, Sammamish, WA (US); Audrey Z. LEI, Bothell, WA (US); Jeremy K. ASOMANING, Lynnwood, WA (US)

(21) Appl. No.: 18/343,709

(22) Filed: Jun. 28, 2023

(51) Int. Cl. G07C 5/00; G06N 20/00; G07C 5/08

(52) U.S. Cl. CPC G07C 5/006; G06N 20/00; G07C 5/0816

(57) ABSTRACT

The present disclosure provides techniques for the deployment of prognostic models into production framework. A machine learning (ML) model trained to predict condition-based aircraft maintenance is accessed. A set of configuration files for executing the ML model are generated based on one or more predefined templates, where the set of configuration files is structured in a hierarchical form based on one or more execution environments for the ML model. The ML model is deployed based on the set of configuration files. Upon determining that a runtime trigger specified in the set of configuration files is activated, input data from a client system is accessed, one or more predictions are generated by processing the input data using the deployed ML model, one or more alert criteria are determined as satisfied based on the predictions, and one or more alerts are output via one or more notification channels.

### FIELD

Aspects of the present disclosure relate to the deployment of machine learning models, and, more specifically, to deploying machine learning models for predicting aircraft maintenance needs based on various conditions.

### BACKGROUND

Aircraft must be well-maintained throughout their lifetime to ensure passenger and bystander safety, whether they are used to transport passengers or equipment. Reducing the frequency of unnecessary groundings can help preserve the aircraft's condition and reduce maintenance interruptions. That is, when an aircraft is grounded for unexpected or unpredicted maintenance work (e.g., due to a detected concern, rather than according to a fixed interval-based schedule of maintenance), substantial delays can be incurred and substantial costs may be imposed. As a result, accurately predicting the needs and timing of aircraft maintenance has become increasingly important, as such accurate prediction allows for effectively extending the aircraft's operational lifespan without compromising safety.

Conventionally, aircraft maintenance uses an interval-based maintenance approach to ensure that the aircraft is in prime condition. Under this approach, regular maintenance tasks are scheduled at set intervals, such as every 2000 flight hours, to decrease the likelihood of unscheduled groundings or delays. This may lower the chances of the aircraft being grounded or delayed. However, even with these regularly scheduled maintenance activities, some aircraft components may degrade prematurely (e.g., prior to scheduled maintenance), particularly near their end-of-life (EOL) or under some special conditions.

### SUMMARY

The present disclosure provides a method in one aspect, the method including: accessing a machine learning (ML) model trained to predict condition-based aircraft maintenance; generating, based on one or more predefined templates, a set of configuration files for executing the ML model, where the set of configuration files is structured in a hierarchical form based at least in part on one or more execution environments for the ML model; deploying the ML model based on the set of configuration files; and upon determining that a runtime trigger specified in the set of configuration files is activated: accessing input data from a client system; generating one or more predictions by processing the input data using the deployed ML model; determining that one or more alert criteria are satisfied based on the one or more predictions; and outputting one or more alerts via one or more notification channels.

Other aspects in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs which, when executed by the one or more computer processors, performs an operation in accordance with one or more of the above methods.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts an example cloud computing environment upon which aspects of the present disclosure may be implemented.

FIG. 2 is a flow diagram of an example method for the deployment of prognostic models, according to some aspects of the present disclosure.

FIG. 3 is a flow diagram of an example method for generating condition-based maintenance alerts by executing the prognostic models, according to some aspects of the present disclosure.

FIG. 4 is a flow diagram of an example method for deploying updated resource files, according to some aspects of the present disclosure

FIG. 5 is a flow diagram depicting an example method for deploying prognostic models to deliver condition-based maintenance alerts, according to some aspects of the present disclosure.

FIG. 6 depicts an example computing system for prognostic model deployment, according to some aspects of the present disclosure.

### DETAILED DESCRIPTION

The present disclosure provides techniques and systems for integrating and/or deploying data-driven prognostic models (e.g., machine learning models) into production frameworks, which enables these prognostic models to continuously monitor aircraft health based on various aircraft parameters and deliver condition-based maintenance alerts to aircraft operators based on their unique requirements.

In some aspects, it has become increasingly useful to develop and use prognostic models (e.g., machine learning models) that can predict when a component is approaching a critical level of degradation, as well as to deploy these models into production based on the unique requirements of different aircraft types and operators. These models, once deployed, can provide real-time (or near real-time) insights into the airplane's health and automatically deliver condition-based maintenance alerts to different aircraft operators. It has been shown that a hybrid approach between the two types of maintenance (regular maintenance and condition-based maintenance) can ensure the highest level of safety.

The present disclosure provides techniques for deploying prognostic models (e.g., machine learning models), trained for predicting condition-based maintenance needs, into a cloud-based computing environment for production purposes. The integration of these prognostic models into the production framework allows the system to continuously monitor the health status of aircraft and automatically deliver real-time maintenance alerts based on different aircraft operators' requirements, thereby enhancing the efficiency of aircraft maintenance and improving the overall performance of airline operations.

The techniques in the present disclosure provide a standardized process for deploying prognostic models, which are trained to predict condition-based maintenance needs, into production use. In some aspects, this process improves the efficiency and accuracy of model deployment (e.g., allowing refined or updated models to be deployed smoothly and reliably with little or no human intervention). This substantially improves the operations of the machine learning training, deployment, and inferencing systems by providing new and useful functionality that reduces error and enhances system reliability. Further, the disclosed processes enhance the efficiency of aircraft maintenance procedures, leading to an overall improvement in airline operations.

In one aspect, the provided techniques may include creating a repository for the trained prognostic models, preparing essential resource files, such as configuration files and scheduling files, and deploying the prognostic models based on these files. In some aspects, after deployment, the provided techniques may further include verifying the activation of a runtime trigger, processing various aircraft operational data received from operators, generating predictions using the deployed prognostic models on this processed data, and outputting condition-based maintenance alerts if the predictions satisfy certain alert criteria. In some aspects, if new requirements arise after the prognostic models have been deployed, the provided techniques further include updating the resource files based on the new requirements, and redeploying the models across different execution environments.

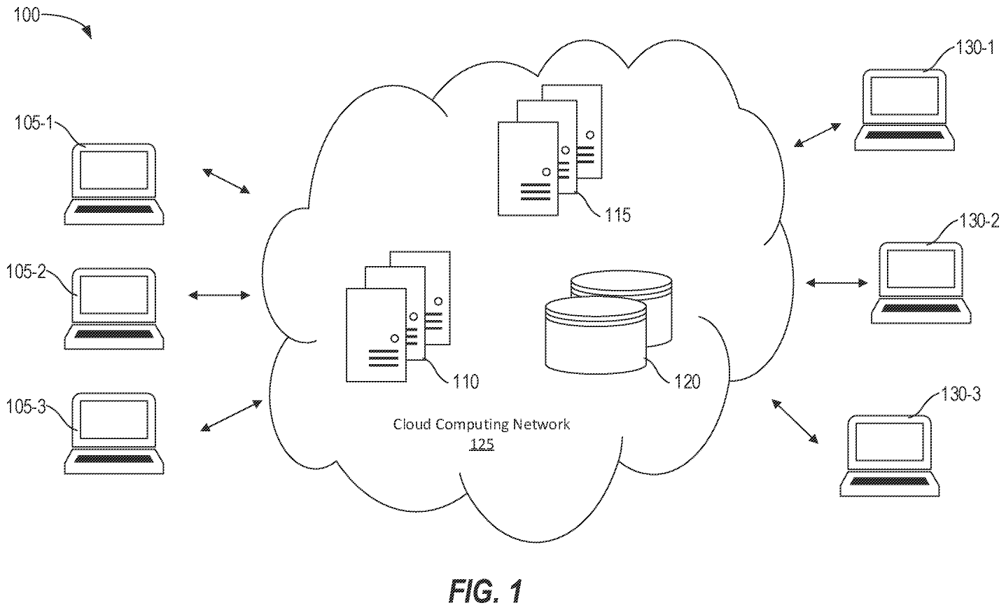

FIG. 1 depicts an example cloud computing environment 100 in which aspects of the present disclosure may be implemented.

In the illustrated example, the cloud computing environment 100 includes one or more computing devices 105-1, 105-2, and 105-3, hereinafter collectively referred to as operator devices 105. For example, the operator devices 105 may be owned, maintained, or otherwise used by aircraft operators responsible for aircraft maintenance and/or operations (e.g., airlines, maintenance entities, and the like). The illustrated example further includes one or more devices 130-1, 130-2, 130-3, hereinafter collectively referred to as manufacturer devices 130, which are owned, maintained, or otherwise used by manufacturing entities (e.g., entities that design and/or manufacture aircraft, or otherwise train and maintain machine learning models to predict aircraft maintenance needs). The cloud computing environment 100 also includes a cloud computing network 125, which further includes one or more servers 110, one or more databases 120, and one or more network infrastructures 115. Both operator devices 105 and manufacturer devices 130 are connected to the cloud computing network 125, and may communicate with the cloud computing network 125 (and the components therein), such as via secure APIs and transfer protocols.

In some aspects, the servers 110 may be any form of computing device that provides various services to the connected devices (e.g., operator devices 105 and manufacturer devices 130). For example, in some aspects, the servers 110 may host the prognostic models that have been trained to predict maintenance needs for different types of aircraft. When receiving instructions or indications that a new operator requires maintenance service (or new service for an existing operator, such as due to adoption of a new aircraft type), such as from one or more manufacturer devices 130, the servers may prepare resource files, such as configuration files (e.g., YAML files) and scheduling files (e.g., formatted as a Directed Acyclic Graph (DAG)), and tailor these documents to the operator's specific requirements.

In some aspects, the servers may deploy the prognostic models based on the generated resource files, and execute the models to generate real-time alerts by processing various aircraft operational data received from operator devices 105. In some aspects, the servers may preprocess the operational data received from devices (e.g., operator devices 105) associated with the aircraft operators. The preprocessing may include cleaning the data, converting it into usable formats (e.g., CSV files), and extracting key features necessary for the prognostic analysis. In some aspects, the servers 110 may create separate resource files (such as configuration files and scheduling files) for each operator and/or for each aircraft or model type, and store the created resource files in a hierarchical structure within the database 120. In some aspects, the resource files created to provide maintenance alert service for different operators and/or aircraft types may be included within a single repository. In some aspects, the servers 110 may create different repositories for each model (e.g., a first trained prognostic model is deployed to a first repository, which stores the resource files for all operators, and a second trained prognostic model is deployed to a second repository with similar resource files for all operators). In some aspects, the servers 110 may track feedback and new data over time, and, based on this feedback, tune the trained prognostic models to improve their accuracies. The servers 110 may handle the deployment of the updated models across different execution environments. Generally, the servers 110 may be implemented using a variety of architectures including as virtual systems, physical servers, and the like, and the operations of the servers 110 may be distributed across any number and variety of computational environments.

In one aspect, the one or more databases 120 may store various types of data, such as data about aircraft operations for one or more aircraft. In some aspects, this data may be uploaded or otherwise provided by the operator devices 105 (automatically or manually). In some aspects, the operational data may include information for specific aircraft types (e.g., specific models of aircraft) and/or for specific aircraft (e.g., for each specific tail number). For example, the operations data may include information such as flight logs (e.g., indicating statistics for each flight, such as duration, timing, weather, maximum altitude, climb and descend rates, take-off and touch-down velocities, and the like), sensor data, and maintenance logs, and the like. In some aspects, the databases 120 may additionally or alternatively store data generated by the manufacturer(s) and/or designer(s) (such as provided by manufacturer devices 130), such as manufacturing data, design specifications, trained prognostic models, resource files tailored to the operator's specific requirements, and preprocessed operational data saved for future computation. In some aspects, the database may include separate virtual and/or physical data partition for each operator and/or aircraft type, where each data partition contains the prognostic models trained and deployed to offer maintenance service for a specific operator, the resource files prepared to meet the operator's requirements, as well as the operational data obtained directly from the operator's activities. In some aspects, the databases 120 may be accessed by the connected devices, such as the operator devices 105 and manufacturer devices 130, to retrieve and/or store data as needed. Although depicted as virtual servers in a cloud computing network, in some aspects, databases 120 are implemented as physical devices or repositories.

In one aspect, the network infrastructures 115 may refer to the hardware and/or software resources that manage data transmission within the network. The network infrastructure may provide various network functions, including routing, switching, firewall management, and load balancing. Although depicted as virtual devices in a cloud computing network 125, in some aspects, the network functions may be performed by physical devices.

In one aspect, the operator devices 105 may take a variety of forms, such as desktop computers, laptop computers, tablet computers, smart phones, smart sensors, or other devices that can be used to interface with the cloud computing network 125. In one aspect, the operator devices 105 may generate, collect, receive, and/or store the real-time data about the aircraft's operations to the one or more database 120 (or to one or more local repositories on a system maintained by the operator). The operational data may then be retrieved (e.g., by the one or more servers 110) for predicting maintenance needs for a specific operator.

In one aspect, the manufacturer devices 130 may similarly take a variety of forms, such as desktop computers, laptop computers, tablet computers, smart phones, smart sensors, or other devices that can be used to interface with the cloud computing network 125. The manufacturer devices 130 may generate and/or upload data that can be fed into prognostic models for maintenance need predictions and/or that may be used to train the prognostic models, such as aircraft specifications, manufacturing data, historical testing results, maintenance records, incident reports, and the like.

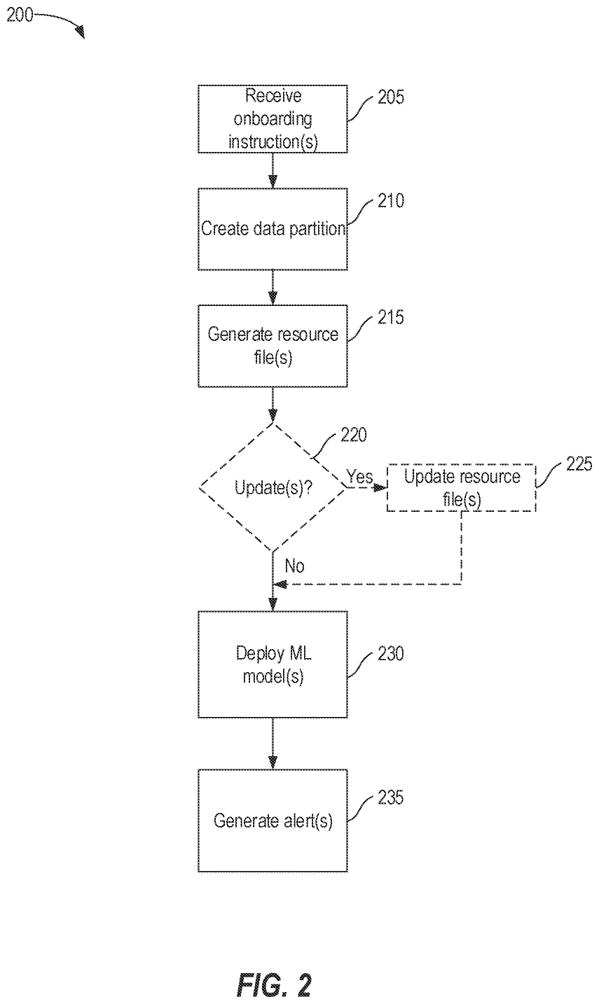

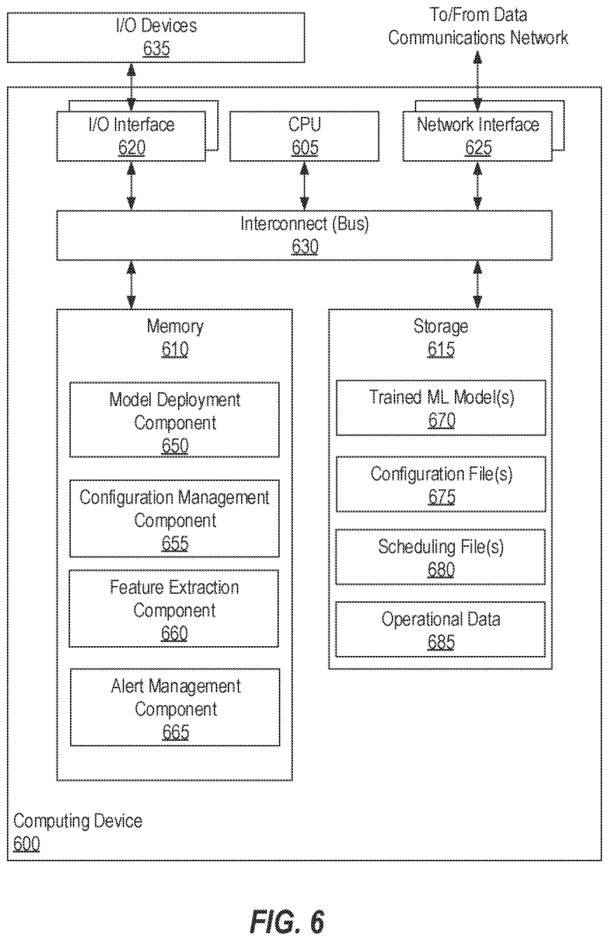

FIG. 2 is a flow diagram depicting an example method 200 for the deployment of prognostic models, according to some aspects of the present disclosure. In some aspects, the method 200 may be performed by a computing device, such as the one or more servers 110 as shown in FIG. 1 and/or the computing device 600 as shown in FIG. 6.

At block 205, a computing system receives onboarding instructions to deploy one or more prognostic models for a new operator (also referred to in some aspects as a new client and/or a new user) and/or instructions to deploy one or more prognostic models for a new aircraft type or deployment. That is, the onboarding instructions may indicate that a newly trained model is to be deployed (e.g., a new prediction model for a new or existing aircraft type) for one or more operators of the relevant aircraft type (regardless of whether the operator is new to the system). In one aspect, the onboarding instructions may be manually entered by a user (e.g., from the manufacturer). In some aspects, the onboarding instructions may be sent by one or more the manufacturer devices 130 to the servers 110 in the cloud computing network 125 via one or more secure APIs and/or transfer protocols. In some aspects, the onboarding instructions may be triggered automatically by an event within the system. For example, when a new operator signs up or registers and submits the relevant information (e.g., using the operator devices 105 of FIG. 1), the system may automatically trigger a system event that sends an onboarding instruction to the computing system (e.g., servers 110 of FIG. 1) to onboard the new operator. Similarly, when an operator begins using a new aircraft type (or a new model becomes available for a prior-deployed aircraft), the system may automatically perform such onboarding.

At block 210, the computing system, upon receiving the onboarding instructions, creates a new data partition for the new deployment (e.g., for the newly registered operator, for the specific aircraft type, and/or for the new model) in a database (e.g., database 120 of FIG. 1). In some aspects, the data partition is used to store various types of data necessary for predicting the operator's maintenance needs. For example, the data partition may include the prognostic models associated with the types of aircraft that the new operator is currently operating. In one aspect, each type of aircraft may have a different prognostic model (or a set of prognostic models) because different types of aircraft may have significant variations in their components, operations, and maintenance requirements. The computing system may select and deploy the prognostic models that correspond to the types of aircraft used by the new operator.

At block 215, the computing system generates resource files for deploying the selected prognostic models for the new operator. In one aspect, the resource files may include configuration files and scheduling files.

In some aspects, the configuration files may include common information that applies across all alerts or operators, as well as operator-specific information that is used to satisfy the unique requirements of the new operator. For example, in one aspect, the common information may include default model parameters or settings, such as the formats of input data for prognostic models or the predefined thresholds for triggering alert criteria. In some aspects, the common information may also include default settings related to the alerts that are generated by the system, such as the default severity level of alerts, or the default format of alert messages. In some aspects, the operator-specific information may include the operator's preferred notification channels, such as emails, text messages, push notifications, or phone calls. Additionally, it may also contain the operator's contract information or destination identifiers, such as email address, phone number, user device identifiers, and the like. The operator-specific information in the configuration files enables the system to deliver maintenance alerts to the operator based on his unique requirements.

In some aspects, the configuration files may be automatically generated from a set of template files. The template files may include variables that are common to all alerts, which may include default model parameters or settings, default alert settings, and the like. In addition, the template files may leave some fields empty to be filled in with the operator-specific information, such as the operator's contact details, preferred notification channels, or any unique requirements. In some aspects, as discussed below, some or all of the configuration files may be hierarchical in nature (e.g., with common or shared configurations applicable to all deployments of the model(s), and more specific configurations for specific operators or deployment or execution environments of each model).

In some aspects, the configuration files for each alert may include multiple configuration files, each created for a different execution environment. For example, the configuration files may include a local configuration file for deploying the prognostic models in a local environment, a development configuration file for deploying the models in a development environment, a configuration file for deploying the models in a testing environment, and a configuration file for deploying the models in a production environment. Each environment-specific configuration file may specify the values or variables that are tailored specifically to that environment.

For example, the local environment may refer to a manufacturer device (e.g., 130 of FIG. 1), on which a developer trains, tests, and/or runs the models locally. The local configuration file may include settings relevant to this local environment, such as settings that enable the deployed models to connect to a local database. The local configuration file may further specify information such as local file paths, and adjust performance settings to make the deployed models compatible with local hardware capabilities. In some aspects, the development environment may refer to a space within a cloud-based computing system (e.g., server 110 of FIG. 1). In some aspects, the models can be deployed to the development environment to facilitate additional development or evaluation of the models. For example, in some aspects, in the development environment, the execution of prognostic models is not dependent on the activation of a runtime trigger. Instead, the models may be manually run (e.g., by developers) to evaluate the model's capacity to appropriately generate alerts.

In some aspects, the testing environment may refer to a space within a cloud-based computing system (e.g., server 110 of FIG. 1) primarily used for assessing the quality and stability of the deployed prognostic models. Unlike the development environment, where model executions are initiated manually, in some aspects the proper functionality of the runtime trigger(s) can be verified in the testing environment. For example, the developer may run tests to check if the runtime trigger is accurately activated (e.g., at predefined intervals or upon the occurrence of specific events). In some aspects, the development configuration files and testing configuration files may include the necessary information to establish connections with a cloud-based database (e.g., database 120 of FIG. 1). The development configuration file and testing configuration file may similarly specify data paths for testing data (e.g., different from real production data received from operator devices). The development configuration file and testing configuration file may similarly adjust for high-level performance settings that are compatible with the hardware capabilities of the cloud-based computing system.

In some aspects, the production environment may refer to a space within a cloud-based computing system (e.g., server 110 of FIG. 1) designed for generating real-time maintenance alerts during runtime (also referred to as inferencing). For example, the production environment may host the deployed prognostic models and analyze incoming data from operator devices continuously (or upon determining that triggering criteria are met). The production configuration file may specify data paths for production data received from operator devices (e.g., 105 of FIG. 1) in real time, and may adjust for high-level performance settings to ensure optimal performance.

In some aspects, the computing system may generate configuration files for different operating systems, if certain values or variables need to be adjusted based on the operating system. For example, the system may generate a configuration file for the Windows system. The system may also generate a configuration file for the Linux or macOS system.

In some aspects, the configuration files for different execution environments and operation systems, as well as the template files (which may be used to generate configuration files for various environments) may be stored in a hierarchical structure within a database (e.g., 120 of FIG. 1). The hierarchical structure is a tree-like arrangement where configuration files are categorized into directories and subdirectories. For example, in one aspect, the root directory (directory with the highest level) may contain the template files, while the specific configuration files (or values to use in populating template files) for each operator, aircraft type, model, and/or environment may be saved in their respective subdirectories. As such, the computing system can manage and update the configuration files efficiently. For example, if a change is needed that affects all operators, the computing system may update the template files in the root directory, and the updates within the template files will be inherited by the configuration files in the subdirectories. In some aspects, the configuration files may be represented as YAML files. In some aspects, other file formats may be used for the configuration files, such as JSON files, and XML files.

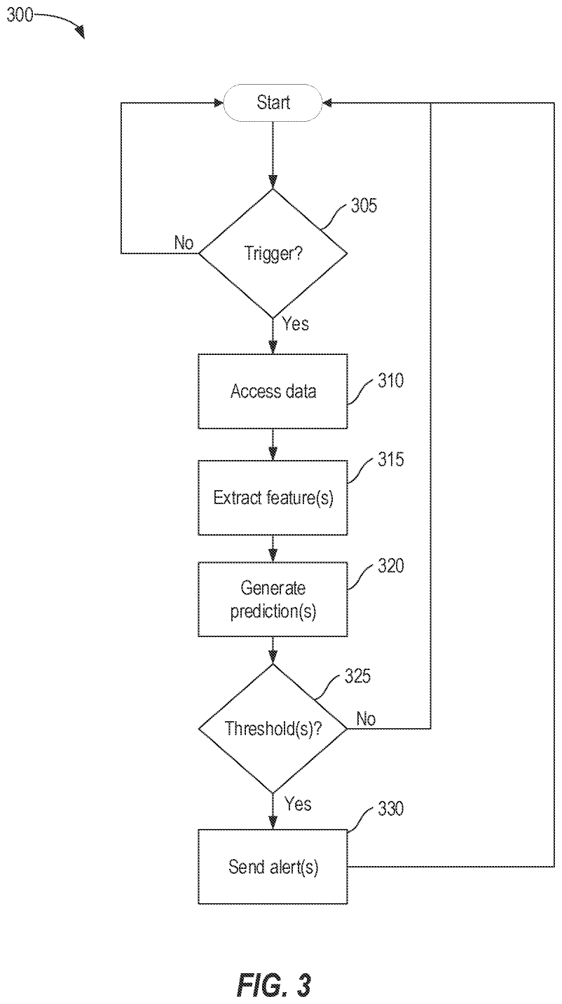

As stated above, the generated resource files also include scheduling files for executing the prognostic models. In one aspect, the scheduling files may be represented as Directed Acyclic Graph (DAGs). The DAG file may list the sequence and dependencies for executing the prognostic models after they have been deployed, which can ensure that certain tasks are completed before the others are initiated, and that the data flows correctly through different components of the models. For example, in some aspects, the DAG file may start with or indicate instructions or operations for preprocessing data and converting the data into useful formats (e.g., CSV files), followed by feature extraction, then model inference, and finally alert generation, as discussed in more detail in FIG. 3.

In some aspects, the scheduling file for each alert may be activated by a runtime trigger. For example, the runtime trigger may be activated at a regular time interval, such as every hour, every day, or every week. The runtime trigger may also be activated when a certain event occurs, such as when new operational data is uploaded to the cloud computing network, or a message requesting a maintenance check is received. In some aspects, the computing system may automatically generate the scheduling files based on template scheduling files. The template scheduling files may include variables that are common to all alerts, and leave some fields to be filled in with operator-specific information. In some aspects, the computing system may generate different scheduling files for different environments, such as the local environment, the development environment, the testing environment, and the production environment. In some aspects, the system may generate different scheduling files for different operating systems, such as the Windows system, the Linux system, and the macOS system. In some aspect, the scheduling files may be represented as JSON files.

At block 220, the computing system may optionally check (depicted as a dash line box) if there are any updates to operator-specific (or aircraft-specific) information, which may include changes in the operator's contact information, the operator's notification preferences, or the addition or removal of certain aircraft from generating maintenance alerts. For example, in some aspects, the system may generate relevant configuration files using default settings, and allow the operator (or other entity) to supply any additional or different information. If any updates are found, the method 200 moves to block 225 (depicted as a dash line box), where the computing system may incorporate the updates into the resource files.

Otherwise, the method proceeds to block 230, where the computing system deploys the prognostic models based at least in part on the generated resources files. In one aspect, the deployment of prognostic models may include loading the prognostic models and the resource files into memory, configuring the system environment based on the settings in the configuration files and scheduling files, setting up any necessary interfaces or connections for the models to receive data and generate predictions, and the like. In some aspects, the computing system may deploy the prognostic models across one or more different execution environments, such as the development, testing, and production environments. When deployed in the development environment, as discussed above the prognostic models may be manually executed without waiting for the activation of a runtime trigger. The prognostic model(s) may be manually run to verify whether they can generate maintenance alerts properly by processing the testing data (which is different from the real-time operational data received from operators).

In some aspects, upon successful deployment in the development environment (e.g., when a user determines that the model deployment is performing as expected), the system can then deploy the prognostic model(s) in the testing environment. In this stage, the models may be initiated when the system detects an activated runtime trigger (which may include actual occurrence of the trigger(s) and/or simulated occurrence). In some aspects, the execution of the models in the testing environment follows the prescribed sequence identified in the scheduling files (e.g., DAG) created specifically for the testing environment.

In some aspects, if the deployment in the testing environment is successful (e.g., as determined by the user), the system may proceed to deploy the prognostic models in the production environment, where the system processes real-time operational data gathered from operator devices (e.g., 105 of FIG. 1) to generate maintenance alerts, which are then sent to the operators based on their preferences.

At block 235, the computing system generates maintenance alerts by executing the prognostic models. One example method for generating maintenance alerts is discussed in more detail below with reference to FIG. 3. In the aspect where the computing system deploys the models across various execution environments, the process of generating maintenance alerts based on operational data from operators may be performed when the models are deployed in the production environment. In some aspects, alerts may be generated in other execution environments, such as testing and/or development, in accordance with corresponding configurations. For example, in the testing environment, alerts may be generated and stored and/or provided to data scientists or other users testing the model, while in production the alerts may be provided to operators.

FIG. 3 depicts a flow diagram of an example method 300 for generating condition-based maintenance alerts by executing the prognostic models, according to some aspects of the present disclosure. In some aspects, the method 300 may be performed by a computing device, such as the one or more servers 110 as shown in FIG. 1 and/or the computing device 600 as shown in FIG. 6.

The method 300 begins at block 305, where a computing system checks whether a runtime trigger for one or more prognostic models has been activated. If the computing system determines the runtime trigger is activated, the method 300 proceeds to block 310, where the computing system accesses the operational data received from the devices associated with the new operator (e.g., 105 of FIG. 1). Otherwise, the method 300 stays in the waiting state and rechecks the status of the runtime trigger periodically or when a specific event occurs. In one aspect, the runtime trigger is time-based and activates at regular intervals, such as every hour, every day, or every week. In some aspects, the runtime trigger is event-driven and activates when a certain event occurs, such as when new operational data is uploaded to the cloud computing network, a message requesting a maintenance check is received, or an operational parameter falls within a certain range of values.

At block 310, the computing system accesses operational data received from operator devices (e.g., 105 of FIG. 1). As discussed above, the operational data may include engine performance data (e.g., engine temperature, oil pressure, fuel consumption rate, etc.), flight data (e.g., altitude, speed, acceleration, the frequency of takeoffs and landings, etc.), environment data (e.g., temperature, humidity, pressure, weather conditions, etc.), regular maintenance and testing results, and other parameters that can be used to monitor the health status of aircraft and predict maintenance needs.

At block 315, the computing system processes the operational data and performs feature extraction. The operational data may be cleaned, normalized, and transformed from raw data into a set of features and values that can be used directly by the prognostic models to generate predictions.

At block 320, the computing system provides the processed data to the prognostic models. The models analyze the data to identify key patterns and trends that may indicate potential maintenance needs. For example, in one aspect, the model may identify unusual patterns in engine performance data that suggest a potential failure of a component. In some aspects, the model may estimate the degradation rate of a specific component based on the current frequency of takeoffs and landings, and, based on that, predict the timing when maintenance is necessary.

At block 325, the computing system compares the generated predictions to predefined thresholds to determine whether one or more alert criteria are satisfied. In some aspects, the predefined thresholds represent the standards at which the predicted issues become critical or maintenance becomes preferred, and therefore a maintenance alert should be sent. If it is determined that the models' predictions satisfy the thresholds, the method 300 proceeds to block 330, where the computing system generates and sends alerts to the corresponding operator devices (e.g., 105 of FIG. 1) as per the corresponding configuration(s) of the model deployment. For example, in one aspect, the prognostic model may be a machine learning (ML) model (or a set of ML models) that is trained to identify unusual patterns in engine performance data and to detect a potential failure of a component within the engine. The computing system may compare the identified patterns with predefined thresholds, which represent values or ranges of values that have been determined to represent normal operation for a specific parameter. If the predictions are above or below the defined thresholds, the computing system may determine that the component within the engine is at risk of potential failure, thereby triggering the alert criteria. In such circumstances, the computing system may generate and send condition-based alerts to the operator. Generally, transmitting the alerts may include directly transmitting them (e.g., to the operator), and/or providing the alert to another user or entity for review before sending the alert to the operators.

As another example, the prognostic model may be a machine learning (ML) model (or a set of ML models) that is trained to estimate the engine's degradation rate based on various operational data. Based on the estimated degradation rate, the computing system may predict that the engine's degradation level will exceed the allowable limit within, for example, the next 40 cycles, and the aircraft is scheduled to perform 50 cycles before the next planned maintenance. As such, the computing system may determine that an alert criteria has been satisfied, and a condition-based maintenance alert should be generated and delivered to the operator.

A number of suitable machine learning algorithms or architectures can be used in the prognostic models, depending on the particular implementation. In some aspects, a neural network architecture may be used, or any other suitable machine learning algorithm can be used.

In the illustrated example, if it is determined that the models' predictions have not exceeded the thresholds, the method 300 returns to block 305, the computing system stays in the waiting state and rechecks the status of the runtime trigger periodically or when a specific event occurs.

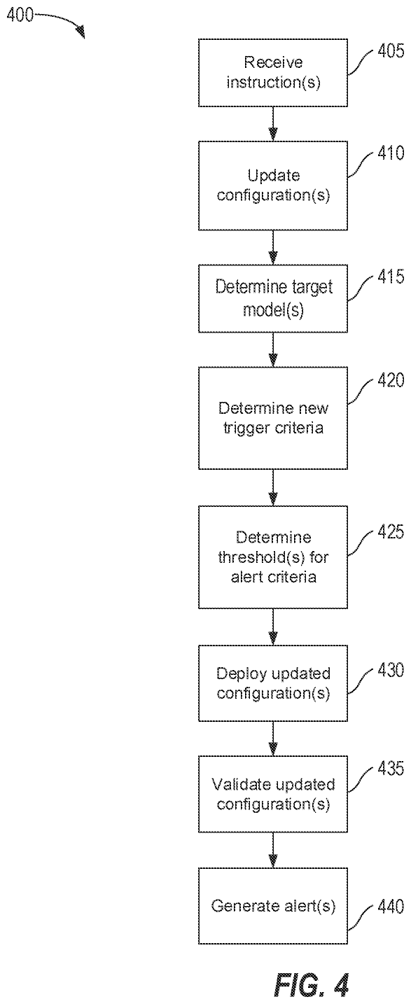

FIG. 4 is a flow diagram of an example method 400 for deploying updated resource files, according to some aspects of the present disclosure. In some aspects, the method 400 may be performed by a computing device, such as the one or more servers 110 as shown in FIG. 1 and/or the computing device 600 as shown in FIG. 6.

After the prognostic models have been deployed, in some aspects, the computing system may monitor for any changes in the operator-specific information that may necessitate an update of the configuration files. For example, the operator-specific information may include an operator's notification preferences (such as emails, text messages, push notifications, or phone calls), contract information (such as email addresses, phone numbers, user device identifiers), the types of aircraft used, the frequency of flights under his operation, and any other information that necessitates an update of the configuration files. In some aspects, the changes may similarly include new alert preferences (e.g., alerts based on new models, alerts based on new thresholds or runtime triggers, and the like).

At block 405, a computing system receives instructions to update the configuration files. In one aspect, the instructions may be initiated by a developer. The developer may identify changes in the operator's requirements, such as changes in notification preferences. After reviewing these changes, the developer may push an instruction to the computing system to update the relevant configuration files. In some aspects, the instructions may be initiated by the operator directly. In some aspects, the instructions may be initiated automatically. For example, the computing system may continuously monitor for changes that may affect the operation of the prognostic models, and, when a change is detected, automatically send an instruction to relevant components to update the configuration files.

At block 410, the computing system updates the configuration files in the operator's data partition, based on the instructions. For example, in one aspect, the computing system may update the operator-specific information in configuration files, such as the operator's preferred notification channels and the operator's contract information. In some aspects, when there are any changes in the deployment environment (local, development, testing, or production), such as changes to database connections or performance level settings, the computing system may similarly update the configuration files created for different execution environments to reflect these changes.

At block 415, the computing system verifies whether the selected prognostic models within a specific operator's data partition are up-to-date. If there have been any updates to the types of aircraft the operator uses (any additions or removals in the operator's fleet), the computing system may select the appropriate models, and add them to or remove them from the operator's data partition. In some aspects, the computing system may similarly determine whether the deployed prognostic models represent the most up-to-date version that is available for production.

At block 420, the computing system determines whether the criteria for the runtime trigger should be adjusted to more accurately and effectively execute the models based on the updated resource files (and/or whether new triggers are being created by the instruction). For example, in one aspect, the adjustment may involve changing the intervals or frequency of model execution when the runtime trigger is a time-based trigger. For example, the system may need to adjust the time intervals from once per week to once per day, when the operator increases the frequency of flights that cause a higher rate of change in the operational data. In another aspect, the adjustment may involve modifying the specific events that initiate a model run when the runtime trigger is an event-based trigger. For example, an event-based runtime trigger is activated when the engine performance data falls within a range of values. When the frequency of flights increases, the system may need to adjust the event-based trigger based on a narrower range of engine performance data, in order to more efficiently utilize the computing resources.

At block 425, the computing system determines whether the predefined thresholds for alert criteria should be updated (based on the instructions). The predefined thresholds are used to trigger alerts based on model predictions, as depicted in more detail in FIG. 3. The thresholds may be adjusted to align with the updated operator's requirements.

At block 430, the computing system deploys the models into different execution environments, such as the development environment, the testing environment, and the production environment. The computing system may create updated configuration files for each relevant environment. For example, the updated configuration files for the development environment and testing environment may specify data paths for testing data, while the updated configuration files for the production environment may include data paths for real production data received from the operator. When deployed in the development environment, the prognostic models are manually executed without waiting for a runtime trigger, to verify if they can generate alerts as expected.

In one aspect, before deploying the updated configurations in the development environment, a developer may first run the updated configurations locally on his computer (e.g., 130 of FIG. 1), to verify that the model works as expected with the updated configurations.

If the deployment in the development environment is successful, in some aspects, the method 400 then moves to block 435, where the computing system deploys the prognostic models in the testing environment for validation.

At block 435, the computing system tests the performance and stability of the model under conditions that simulate those of the production environment. In the testing environment, the model execution is based on actual runtime triggers, and guided by the prescribed sequence identified in the scheduling files (e.g., DAG) created for the testing environment. If the deployment in the testing environment is successful, the method 400 proceeds to block 440.

At block 440, the computing system deploys the prognostic models in the production environment, where the system processes real-time operational data received from operator devices (e.g., 105 of FIG. 1) to generate maintenance alerts.

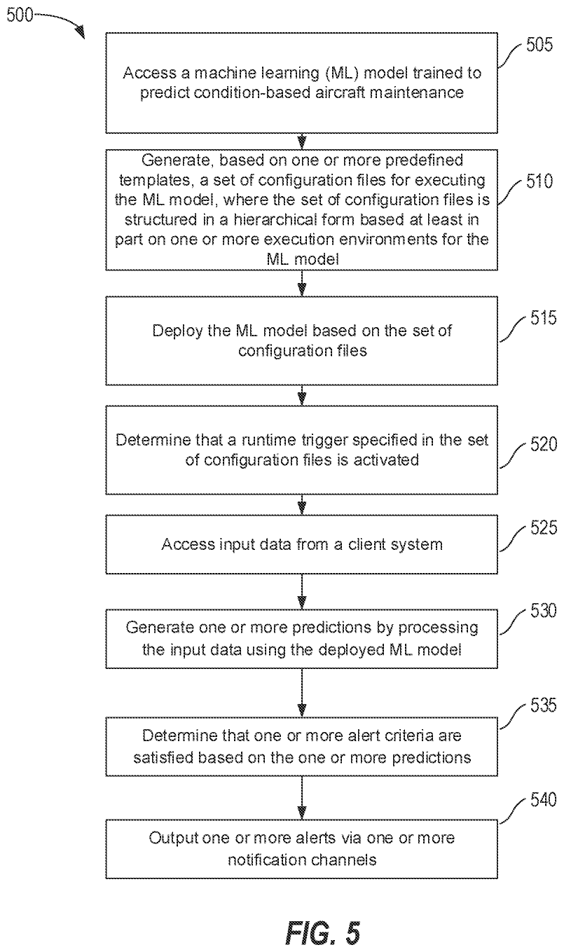

FIG. 5 is a flow diagram depicting an example method 500 for deploying prognostic models to deliver condition-based maintenance alerts, according to some aspects of the present disclosure.

The method 500 begins at block 505, where a system (e.g., the computing system in server 110 of FIG. 1, or the computing system in device 600 of FIG. 6) accesses a machine learning (ML) model trained to predict condition-based aircraft maintenance.

At block 510, the system generates, based on predefined templates, a set of configuration files for executing the ML model (as depicted in blocks 215 and 225 of FIG. 2). In some aspects, the set of configuration files is structured in a hierarchical form based at least in part on one or more execution environments for the ML models (such as the local environment, the development environment, the testing environment, and the production environment). In some aspects, the set of configuration files may specify the runtime trigger, the alert thresholds for alert criteria, the notification channels (e.g., emails, text messages, push notifications, or phone calls) and destination identifiers (e.g., email addresses, phone numbers, user device identifiers), and feature extraction information for one or more different aircraft types. In some aspects, the set of configuration files includes: a development configuration file for deploying the ML model in a development environment, where the ML model is manually triggered to generate alerts in the development environment (as depicted in block 230 of FIG. 2, and block 430 of FIG. 4); a test configuration file for deploying the ML model in a testing environment, where the ML model is tested to determine that the runtime trigger is activated automatically in the testing environment (as depicted in block 230 of FIG. 2, and block 435 of FIG. 4); and a production configuration file for deploying the ML model in a client-facing production environment, where the ML model is used for runtime inferencing in the production environment (as depicted in block 230 of FIG. 2, and block 440 of FIG. 4).

At block 515, the system deploys the ML model based on the set of configuration files (as depicted in block 230 of FIG. 2). In some aspects, the system deploys the ML model to a cloud-based computing system (e.g., 110 of FIG. 1).

At block 520, the system determines that the runtime trigger specified in the set of configuration files is activated. In one aspect, the runtime trigger is time-based that activates at regular intervals. In some aspects, the runtime trigger is event-driven that activates when a certain event occurs.

At block 525, the system accesses input data (e.g., data about the aircraft's operation) from a client system (e.g., operator device 105 of FIG. 1).

At block 530, the system generates one or more predictions by processing the input data using the deployed ML models (as depicted in block 320 of FIG. 3).

At block 535, the system determines that one or more alert criteria are satisfied based on the one or more predictions (as depicted in block 325 of FIG. 3).

At block 540, the system outputs one or more alerts via one or more notification channels (as depicted in block 330 of FIG. 3). In some aspects, the system may store the alerts in a cloud-based database (e.g., 120 of FIG. 1). In some aspects, the notification channels may include email, text message, push notification, and phone call.

In some aspects, the system may further update the set of configuration files based on one or more client inputs (as depicted in block 410 of FIG. 4), validate the updated set of configuration files across one or more execution environments (e.g., development environment, testing environment, and production environment), and redeploy the ML model based on the updated set of configuration files (as depicted in blocks 430-440 of FIG. 4).

In some aspects, the system, upon determining that the runtime trigger specified in the set of configuration files is activated, may access new input data from a client system (as depicted in block 325 of FIG. 3), generate one or more new predictions by processing the new input data using the deployed ML model (as depicted in block 320 of FIG. 3), determine that one or more alert criteria are not satisfied based on the one or more new predictions (as depicted in block 325 of FIG. 3), and refrain from generating new alerts based on the new input data.

FIG. 6 depicts an example computing system for prognostic model deployment, according to some aspects of the present disclosure. In one aspect, the computing device 600 may be implemented using a virtual device. In another aspect, the computing device 600 may be implemented using virtual device(s), and/or across a number of devices in a cloud environment, such as the servers 110 as illustrated in FIG. 1.

As illustrated, the computing device 600 includes a CPU 605, memory 610, storage 615, one or more network interfaces 625, and one or more I/O interfaces 620. In the illustrated example, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some aspects, I/O devices 635 (such as keyboards, monitors, etc.) are connected via the I/O interface(s) 620. Further, via the network interfaces 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

As illustrated, the memory 610 includes a model deployment component 650, a configuration management component 655, a feature extraction component 660, and an alert management component 665.

Although depicted as a discrete component for conceptual clarity, in some aspects, the operations of the depicted component (and others not illustrated) may be combined or distributed across any number of components. Further, although depicted as software residing in memory 610, in some aspects, the operations of the depicted components (and others not illustrated) may be implemented using hardware, software, or a combination of hardware and software.

In one aspect, the model deployment component 650 may be configured to deploy the trained prognostic models across various execution environments, such as the development environment, the testing environment, and the production environment. For example, the model deployment component 650 may load the prognostic models and the resource files into memory, configuring the system based on the settings in the resource files for different environments, and setting up any necessary interfaces or connections for the models to receive data and generate predictions. In some aspects, the model deployment component 650 may also be responsible for verifying whether the models are functioning as expected. For example, the model deployment component 650 may check whether the runtime trigger is activated as scheduled. If the runtime trigger fails to be activated as expected, the component may identify the potential issues, and send a notification to a developer's device (e.g., manufacture devices 130 of FIG. 1). If the runtime trigger is activated as scheduled, the model deployment component 650 may then move forward to verify whether the deployed models respond correctly when a runtime trigger is activated. For example, the model deployment component 650 may check if the deployed models can access and process operational data properly, generate valid predictions, and transmit alerts to operators when necessary. In some aspects, the model deployment component 650 may also be responsible for deploying the prognostic models across various environments based on updated configuration files. This may involve updating the data partition to include proper prognostic models, incorporating new trigger criteria when needed, and updating the predefined thresholds for alert criteria within deployed models if necessary.

In one aspect, the configuration management component 655 may be configured to create, update, and manage resource files (including configuration files and scheduling files in some aspects) for different operators and environments. For example, the configuration management component 655 may create a distinct data partition in a remote database (e.g., 120 of FIG. 1) or local storage (e.g., 615 of FIG. 6) for each operator that has requested the maintenance alert service. The data partition may contain all files related to that operator, including trained prognostic models, configuration files, scheduling files, and preprocessed operational data from the operator. The configuration management component 655 may also be configured to generate specific resource files for each execution environment (development, testing, and production). The configuration management component 655 may generate the resource files based on a set of templates, and store the files in a hierarchical structure to ensure easy access, retrieval, and update of the files whenever necessary.

In one aspect, the feature extraction component 660 may be configured to preprocess the received operational data (e.g., from operator devices 105 of FIG. 1), and extract key features required for model execution.

In one aspect, the alert management component 665 may be configured to handle the generation and delivery of maintenance alerts based on the predictions of the prognostic models. The alert management component 665 may manage the predefined thresholds for alert criteria, determine whether an alert should be sent based on the model predictions and the thresholds, and oversee the delivery of the alerts to the operators (e.g., operator devices 105 of FIG. 1) through the preferred notification channels specified in the configuration files.

In the illustrated example, the storage 615 may include trained ML models 670 for prognostic predictions, configuration files 675, scheduling files 680, and operational data 685. In some aspects, as depicted in FIG. 1, the aforementioned information may be saved in a remote database 120 that connects to the computing device 600 via a network.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method, comprising:
accessing a machine learning (ML) model trained to predict condition-based aircraft maintenance;
generating, based on one or more predefined templates, a set of configuration files for executing the ML model, wherein the set of configuration files is structured in a hierarchical form based at least in part on one or more execution environments for the ML model;
deploying the ML model based on the set of configuration files; and
upon determining that a runtime trigger specified in the set of configuration files is activated:
accessing input data from a client system;
generating one or more predictions by processing the input data using the deployed ML model;
determining that one or more alert criteria are satisfied based on the one or more predictions; and
outputting one or more alerts via one or more notification channels.

2. The method of claim 1, wherein the set of configuration files specifies at least one of (i) the runtime trigger, (ii) one or more alert thresholds for the one or more alert criteria, (iii) the one or more notification channels and destination identifiers, and (iv) feature extraction information for one or more different aircraft types.

3. The method of claim 1, wherein the one or more notification channels comprises at least one of (i) email, (ii) text message, (iii) push notification, and (iv) phone call.

4. The method of claim 1, further comprising storing the one or more alerts in a cloud-based database.

5. The method of claim 4, wherein deploying the ML model based on the set of configuration files comprises deploying the ML model to a cloud-based computing system.

6. The method of claim 1, wherein the set of configuration files comprises:
a development configuration file for deploying the ML model in a development environment, wherein the ML model is manually triggered to generate alerts in the development environment,
a test configuration file for deploying the ML model in a testing environment, wherein the ML model is tested to determine that the runtime trigger is activated automatically in the testing environment, and
a production configuration file for deploying the ML model in a client-facing production environment, wherein the ML model is used for runtime inferencing in the production environment.

7. The method of claim 1, further comprising:
updating the set of configuration files based on one or more client inputs;
validating the updated set of configuration files across the one or more execution environments; and
redeploying the ML model based on the updated set of configuration files.

8. The method of claim 1, further comprising:
upon determining that the runtime trigger specified in the set of configuration files is activated for a second time:
accessing new input data from a client system;
generating one or more new predictions by processing the new input data using the deployed ML model;
determining that the one or more alert criteria are not satisfied based on the one or more new predictions; and
refraining from generating new alerts based on the new input data.

9. A computer program product comprising one or more computer-readable storage media collectively containing computer-readable program code that, when executed by operation of one or more computer processors, performs an operation comprising:
accessing a machine learning (ML) model trained to predict condition-based aircraft maintenance;
generating, based on one or more predefined templates, a set of configuration files for executing the ML model, wherein the set of configuration files is structured in a hierarchical form based at least in part on one or more execution environments for the ML model;
deploying the ML model based on the set of configuration files; and
upon determining that a runtime trigger specified in the set of configuration files is activated:
accessing input data from a client system;
generating one or more predictions by processing the input data using the deployed ML model;
determining that one or more alert criteria are satisfied based on the one or more predictions; and
outputting one or more alerts via one or more notification channels.

10. The computer program product of claim 9, wherein the set of configuration files specifies at least one of (i) the runtime trigger, (ii) one or more alert thresholds for the one or more alert criteria, (iii) the one or more notification channels and destination identifiers, and (iv) feature extraction information for one or more different aircraft types.

11. The computer program product of claim 9, wherein the one or more notification channels comprises at least one of (i) email, (ii) text message, (iii) push notification, and (iv) phone call.

12. The computer program product of claim 9, further comprising storing the one or more alerts in a cloud-based database.

13. The computer program product of claim 12, wherein deploying the ML model based on the set of configuration files comprises deploying the ML model to a cloud-based computing system.

14. The computer program product of claim 9, wherein the set of configuration files comprises:
a development configuration file for deploying the ML model in a development environment, wherein the ML model is manually triggered to generate alerts in the development environment,
a test configuration file for deploying the ML model in a testing environment, wherein the ML model is tested to determine the runtime trigger being activated automatically in the testing environment, and
a production configuration file for deploying the ML model in a client-facing production environment, wherein the ML model is used for runtime inferencing in the client-facing production environment.

15. The computer program product of claim 9, further comprising:
updating the set of configuration files based on one or more client inputs;
validating the updated set of configuration files across the one or more execution environments; and
redeploying the ML model based on the updated set of configuration files.

16. The computer program product of claim 9, further comprising:
upon determining that the runtime trigger specified in the set of configuration files is activated for a second time:
accessing new input data from a client system;
generating one or more new predictions by processing the new input data using the deployed ML model;
determining that the one or more alert criteria are not satisfied based on the one or more new predictions; and
refraining from generating new alerts based on the new input data.

17. A system, comprising:
one or more computer processors; and
a memory containing a program which when executed by the one or more computer processors performs an operation, the operation comprising:
accessing a machine learning (ML) model trained to predict condition-based aircraft maintenance;
generating, based on one or more predefined templates, a set of configuration files for executing the ML model, wherein the set of configuration files is structured in a hierarchical form based at least in part on one or more execution environments for the ML model;
deploying the ML model based on the set of configuration files; and
upon determining that a runtime trigger specified in the set of configuration files is activated:
accessing input data from a client system;
generating one or more predictions by processing the input data using the deployed ML model;
determining that one or more alert criteria are satisfied based on the one or more predictions; and
outputting one or more alerts via one or more notification channels.

18. The system of claim 17, wherein the set of configuration files specifies at least one of (i) the runtime trigger, (ii) one or more alert thresholds for the one or more alert criteria, (iii) the one or more notification channels and destination identifiers, and (iv) feature extraction information for one or more different aircraft types.

19. The system of claim 17, further comprising:
updating the set of configuration files based on one or more client inputs;
validating the updated set of configuration files across the one or more execution environments; and
redeploying the ML model based on the updated set of configuration files.

20. The system of claim 17, further comprising:
upon determining that the runtime trigger specified in the set of configuration files is activated for a second time:
accessing new input data from a client system;
generating one or more new predictions by processing the new input data using the deployed ML model;
determining that the one or more alert criteria are not satisfied based on the one or more new predictions; and
refraining from generating new alerts based on the new input data.
